(19) United States
(12) Patent Application Publication
(10) Pub. No.: US 2014/0069298 A1
(43) Pub. Date: Mar. 13, 2014

(54) OIL- AND WAX-CONTAINING AGENTS IN PIECE FORM COMPRISING PARTICULAR WAX MIXTURES FOR THE COLORING OF ASPHALT AND BITUMEN

(71) Applicants: Krzysztof Chlopek, Krefeld (DE); Jurgen Kischkewitz, Ratingen (DE); Lutz Kohnert, Duisburg (DE); Holger Inden, Wuppertal (DE)

(72) Inventors: Krzysztof Chlopek, Krefeld (DE); Jurgen Kischkewitz, Ratingen (DE); Lutz Kohnert, Duisburg (DE); Holger Inden, Wuppertal (DE)

(73) Assignee: LANXESS DEUTSCHLAND GMBH, Leverkusen (DE)

(21) Appl. No.: 13/997,439

(22) PCT Filed: Dec. 30, 2011
(86) PCT No.: PCT/EP2011/074308

§ 371 Date: Nov. 22, 2013

(30) Foreign Application Priority Data
Dec. 30, 2010 (EP) 10197397.2

(51) Int. Cl. C08K 5/01; C08K 3/22; C08L 95/00

(52) U.S. Cl. CPC C08K 5/01; C08L 95/00; C08K 3/22
USPC 106/272; 106/460

(57) ABSTRACT

The present invention concerns agents containing at least one inorganic pigment, one or more oils, at least one Fischer-Tropsch wax and at least one second wax, processes for production thereof and their use for coloration of building products, preferably asphalt, bitumen, bituminous mixtures, tar and tar-containing compositions, and also a process for coloration of building products and the building products colored with the agents.

The present invention concerns agents containing at least one inorganic pigment, one or more oils, at least one Fischer-Tropsch wax and at least one second wax, processes for production thereof and their use for coloration of building products, preferably asphalt, bitumen, bituminous mixtures, tar and tar-containing compositions, and also a process for coloration of building products and the building products colored with the agents.

### FIELD OF USE

The processing of pigments to achieve optimal color impression requires that the pigments be ground to form primary particles. The resultant powders are very prone to dusting and tend to stick to each other and to packaging, machine parts and metering equipment because of their fine state of subdivision. Substances recognized as hazardous by toxicologists therefore require that measures be taken in the course of processing to avoid any harm to humans and the environment due to resultant dusts. But even in the case of unconcerning inert substances, such as iron oxide pigments for example the market is increasingly demanding dust nuisance control.

Dust avoidance and improved metering due to good flow properties to achieve a qualitatively uniform color impression on use in building products and organic media is therefore the goal of pigment handling. This goal is more or less achieved by applying granulation processes to pigments.

Granular pigments, by whichever method they are produced, are in principle required by the market to have two contradictory properties: mechanical stability (abrasion stability) on the part of the granule and good dispersing properties in the medium used. Mechanical stability is responsible for good transport properties not only in relation to the transport between the producer and the user but also for good metering and properties of flow when the pigments come to be used. Mechanical stability is due to high bonding forces and depends for example on binder quantity and type. On the other hand, dispersibility is influenced by good grinding prior to granulation (wet and dry grinding), by the mechanical energy at incorporation into the particular application medium (shearing forces) and by dispersion assistant which immediately reduce the bonding forces in the pellet in the course of incorporation in a medium. If optimal color impression is to be achieved, the pigment granules have to subdivide into primary particles. In the case of inorganic pigments, the use of comparatively large amounts of dispersion assistant is constrained by the cost ratio of auxiliary/pigment.

For coloration of building products, such as asphalt for example, the pigments are still being used in a pulverulent state in some instances. They have the advantage of good dispersibility when ground. Complete and homogeneous dispersal of such pulverulent inorganic pigments in the asphalt mixer is effected within a short time—generally within one minute. The disadvantage of these fine powders is that they do not have good flowability and they are frequently prone to cake and clump together if improperly stored. They stick to packaging and machine parts, which compromises accurate metering during processing. A further disadvantage with powders is that they are prone to dusting.

### PRIOR ART

Dust avoidance and improved metering in the use of pigments for coloration of organic media, especially asphalt, is a primary objective because asphalt-mixing facilities are very often localized in residential districts.

According to U.S. Pat. No. 3,778,288, granules can be produced as “masterbatches” by addition of waxes in a progressive-agglomeration process via a heatable mixer. Different particle sizes are obtained depending on reaction conditions. These granules are used in the coloration of polymers such as plastics, waxes or resins. The best particle sizes for granules used in such applications are between 0.2 and 2 mm (70 to 10 mesh). The waxes, which are used as binders, are preferably used in concentrations of 26% to 65% based on the total amount of the composition. This high binder fraction is disadvantageous for use in the coloration of building products, since the binder can have an adverse effect on the properties of building products. Moreover, distinctly higher amounts of “masterbatch” are needed compared with the pulverulent inorganic pigment to achieve the same coloring effect, making the use uneconomical.

EP 0 567 882 A 1 describes a process for coloration of asphalt and/or bitumen with inorganic pigment granules wherein the granules can be formed by addition of oils and/or waxes. The stated amount of additives (0.01- to 10 wt % based on pigment) does improve the dispersibility of granules in bitumen, but this process is not capable of providing granules having sufficient mechanical stability.

EP 1 598 395 A 1 describes a composition based on copolymers of ethyl vinyl acetate useful as an admixture to asphalt. Extrusion granules are concerned here. A person skilled in the art is aware that plastics extrusion with iron oxide leads to considerable wear of asphalt-processing equipment due to the abrasive properties of the pigment.

U.S. Pat. No. 6,706,110 B2 and U.S. Pat. No. 6,780,234 B2 disclose pigment granules for the coloration of apolar media such as asphalt and bitumen by addition of waxes and dispersing agents for polar media. Their method of making is a spray-granulation process of aqueous systems. Spray granulation predicates dropletization and so requires the use of readily flowable, i.e., liquid, suspensions. Since a comparatively large amount of water has to be evaporated for drying, however, the process is energy intensive and therefore advantageous to use in particular when the pigments to be granulated are in the wet phase, for example in an aqueous suspension or paste, by virtue of their method of making. In the case of pigments obtained via a dry method of making, for example calcination, spray granulation is an additional operation, since the as-obtained dry pigment has to be resuspended in water and dried. In addition, granules obtained via spray granulation have a particle size between 20 to 500 μm, which causes significant dusting in the metered addition. Particles less than 1 mm in size still count as dust from the viewpoint of protecting the employees involved in asphalt processing.

Pigment compositions provided in the prior art are unsuitable for safe and economical use in the coloration of building products that are processed at temperatures higher than ambient, such as asphalt, bitumen, bituminous mixtures, tar and tar-containing compositions.

The problem addressed by the present invention was accordingly that of providing low-dust, readily meterable agents which contain inorganic pigments, are obtainable in an economical manner, are useful for coloration of building products that are processed at temperatures higher than ambient, and ideally have no adverse effect on the mechanical strength of the building product.

The stated is surprisingly solved by providing agents which in addition to at least one inorganic pigment and at least one oil contain at least two different waxes.

The invention accordingly provides an agent where at least 50 wt % of the agent has a particle size of 1 mm or more, preferably of 1 to 10 mm and more preferably 1 to 6 mm, containing
at least one inorganic pigment,
one or more oils,
at least one Fischer-Tropsch wax having a congealing point between 50 and 140° C., preferably between 70 and 120° C., more preferably between 80 and 110° C. and most preferably between 90 and 110° C., and a needle penetration at 25° C. of up to 1 mm, preferably up to 0.7 mm, more preferably up to 0.4 mm, and
at least one second wax having a congealing point between 50 and 140° C., preferably between 70 and 120° C., more preferably between 80 and 110° C. and most preferably between 90 and 110° C., wherein this wax is not a Fischer-Tropsch wax nor a polyolefin wax.

The agent of the present invention preferably contains an oil, a Fischer-Tropsch wax and a second wax. It is preferable for at least 70 wt % and more preferable for at least 80 wt % of the agent to have a particle size of 1 mm or more, preferably of 1 to 10 mm and more preferably 1 to 6 mm.

The agent of the present invention fully meets the requirements concerning dispersibility in application media and concerning the hue obtained in the colored application media compared with the ungranulated pigment powder, and does not have an adverse effect on the properties of the building product (e.g., the strength of asphalt under mechanical loading) colored with the agent. Mechanical strength is an essential property of asphalt. Reduced mechanical strength increases the tendency, for example, of ruts developing when vehicles travel along roads or paths covered with this asphalt.

The agent of the present invention is in piece form. “Agent” hereinbelow is to be understood as meaning agglomerates of primary particles, these agglomerates differing in their maximum spatial extent from that of primary particles. “Agent” also comprehends granules. “Granule” or “in granular form” in the context of the invention is to be understood as meaning any material whose average particle size has been increased, compared with the starting materials, by a treatment step. “Granule” or “in granular form” therefore comprehends not just sprayed granules, compacted granules (pressed or briquetted granules) or progressive-agglomeration granules, but also, for example, products of a wet or moist treatment with subsequent comminution, and products of dry or essentially dry processing steps, for example dry-produced granules, briquettes and the like. The agents of the present invention are preferably progressive-agglomeration granules, more preferably progressive-agglomeration granules produced via a heatable mixer.

The agents of the present invention are preferably in the form of spherical agglomerates, and these can have not only the shape of a sphere but also the shape of an ellipsoid and also intermediate forms thereof.

It may be pointed out that the ambit of the invention also encompasses any desired combinations of recited ranges and preferences for every feature including combinations of preference ranges.

In the agents of the present invention, the inorganic pigments are preferably selected from the group of iron oxides, iron oxide hydroxides, chromium oxides, titanium dioxides and/or mixed-phase pigments based on metal oxides. Iron oxides include for example hematite (iron oxide red) or magnetite (iron oxide black). Iron oxide hydroxides include for example goethite (iron oxide yellow). Mixed-phase pigments based on metal oxides are, for example, zinc ferrites (mixed-phase pigment from zinc oxide and iron oxide) or manganese ferrites (mixed-phase pigment from manganese oxide and iron oxide). The agent of the present invention may contain one or more inorganic pigments. Preferably, the agent of the present invention contains one inorganic pigment.

The agents of the present invention contain one or more oils. Oils in the context of the present invention are non-polar or slightly polar substances which are liquid at room temperature and not volatile. Preference among this group is given to oils selected from the group of synthetic oils, mineral oils (obtained from petroleums or coals), animals oils or vegetable oils. Preference is likewise given to oils having a kinematic viscosity of 1.6 to 1500 mm²/s at 40° C. (measured to DIN 51562). It is particularly preferable for the agents of the present invention to contain synthetic oils based on hydrocarbons, or mineral oils (obtained from petroleums or coals).

In the agents of the present invention, the total amount of oil or oils is preferably from 0.1% to 5.0 wt %, more preferably from 0.5 to 3 wt %, based on the total amount of the agent. The agent of the present invention may contain one or more oils. Preferably, the agent of the present invention contains one oil.

Wax refers to a substance which is coarse to finely crystalline, melts above 40° C. without decomposition and is non-ropey and of comparatively low viscosity even just above the melting point.

Fischer-Tropsch waxes are synthetic aliphatic hydrocarbons, i.e., synthetic paraffin waxes having a high molecular mass and a chain length of 20 to 120 carbon atoms. Fischer-Tropsch waxes are produced via the so-called Fischer-Tropsch process from syngas (hydrogen, carbon monoxide) from coal gasification or from natural gas in the presence of catalysts. The group of Fischer-Tropsch waxes also includes oxidized Fischer-Tropsch waxes. Fischer-Tropsch waxes generally have a congealing point of greater than 70° C. The congealing point, which is technically more important for the processing of waxes than the melting point is, is a physical property of waxes which is often measured instead of the melting point. The congealing point can be measured to ISO 2207 or to ASTM D 938.

Fischer-Tropsch waxes are relatively hard, which can be measured via the needle penetration at 25° C. in the unit “mm”. The Fischer-Tropsch waxes preferably have a needle penetration at 65° C. of up to 3 mm.

Methods for measuring the needle penetration at different temperatures, for example 25° C. or 65° C., include the methods of ASTM D 1321 or DIN 51579 for example. Typical values of needle penetration at 25° C. for Fischer-Tropsch waxes are in the range from 0.1 mm to 1 mm. The agent of the present invention may contain one or more Fischer-Tropsch waxes. Preferably, the agent of the present invention contains one Fischer-Tropsch wax.

The “second wax” in the agent of the present invention is neither a Fischer-Tropsch wax nor a polyolefin wax. Polyolefin waxes are waxes formed by polymers of derivatized or nonderivatized alkenes, for example ethylene, propylene or styrene (phenylethene), which are produced by chain growth addition polymerization.

The second wax is preferably selected from the group of mineral waxes, montan waxes, vegetable waxes and/or animal waxes. Mineral waxes are mixtures of normal, branched-chain or ring-shaped saturated hydrocarbons, which are obtained by refining waxes of fossil origin, for example ceresin. Montan waxes are natural waxes which are extractable from lignite varieties. These natural waxes have formed from resins, waxes and fats of Tertiary plants. Sugar cane wax and carnauba wax are examples of vegetable waxes. Animal waxes include spermaceti, lanolin and beeswax.

Waxes particularly useful as second wax come from the abovementioned groups and have a dynamic viscosity at 120° C. of less than 800 mPas, preferably of less than 300 mPas and more preferably of from 1 to 100 mPas (measured to DIN 53019). Preference for use as second wax is given to mineral waxes, more preferably microcrystalline hard waxes. They form part of the group of mineral waxes. It is very particularly preferable for the agents of the present invention to contain microcrystalline hard waxes having a dynamic viscosity at 120° C. of 1 to 100 mPas as second wax. The agent of the present invention may contain one or more “second waxes”. Preferably, the agent of the present invention contains one “second wax”.

It is preferable for the proportion of Fischer-Tropsch wax in the agent of the present invention to be from 20 wt % to 80 wt %, more preferably from 30 to 70 wt % and most preferably from 35 to 65 wt %, based on the total amount of Fischer-Tropsch wax and second wax. The total amount of Fischer-Tropsch wax and second wax in the agents of the present invention is preferably from 5 to 25 wt %, more preferably from 8 to 20 wt % and most preferably from 10 to 18 wt %, based on the total amount of the agent.

The Fischer-Tropsch waxes and the second waxes may be present therein in their original, i.e., chemically unmodified, form, or in their chemically modified forms.

The agents of the present invention may additionally contain further, auxiliary materials which, however, must not diminish the properties of the agent such as dust characteristics, doseability and dispersibility and also the mechanical strength of the asphalt colored with these agents, or the agents of the present invention simply do not contain these further, auxiliary materials.

The agent of the present invention more preferably contains the combination of iron oxide or chromium oxide, a mineral oil, a Fischer-Tropsch wax and a microcrystalline hard wax.

The invention also provides processes for producing the agents of the present invention in three alternative embodiments (variants A, B or C), characterized in that
a) at least one inorganic pigment is mixed with one or more oils and
b) the mix of step a) is mixed with one or more Fischer-Tropsch waxes and one or more second waxes,
c) the mixture of step b) is further mixed at a temperature above the congealing points of the Fischer-Tropsch waxes and of the second waxes (variant A),
or
a′) at least one inorganic pigment is mixed with one or more Fischer-Tropsch waxes and one or more second waxes and
b′) the mix of step a′) is mixed with one or more oils,
c′) the mixture of step b′) is further mixed at a temperature above the congealing points of the Fischer-Tropsch waxes and of the second waxes (variant B),
or
at least one inorganic pigment is simultaneously mixed with one or more oils and with one or more Fischer-Tropsch waxes and one or more second waxes, and the mixture is then further mixed at a temperature above the congealing points of the Fischer-Tropsch waxes and of the second waxes (variant C).

The process of forming the agent may in this context also be referred to as constructing the granule by progressive agglomeration. Preferred embodiments of variants A, B and C of the process according to the present invention utilize as oils, Fischer-Tropsch wax and second wax the specific products which were disclosed under these generic terms in the course of the description of the agent of the present invention.

The production process of variants A, B and C preferably comprises the steps whereby the agent formed is cooled down to ambient temperature and then sieved to a particle size range such that at least 50 wt %, preferably at least 70 wt % and more preferably at least 80 wt %, of the agent has a particle size of 1 mm or more, preferably from 1 to 10 mm and more preferably from 1 to 6 mm; or does not comprise these steps. Cooling the agent down to ambient temperature may or may not be done in a vibratory conveyor or fluidized-bed cooler or in some other way with liquid or gaseous media.

The production processes for variants A, B and C may also be practiced with or without the over- and/or undersize obtained after sieving, i.e., the agent above and/or below the desired particle size, be recycled into the production process for the agent. During the production process, the recycled over- and/or undersize combines with the other components introduced into the process to form the agents of the present invention.

Steps a) or a′) in the embodiments of the process according to the present invention where the oil or oils, the Fischer-Tropsch wax and the second wax are added to the inorganic pigment in succession (variants A and B) are preferably carried out below the congealing points of the Fischer-Tropsch wax and of the second wax. Adding the oil or oils in variant A or the waxes in variant B to the inorganic pigment can be carried out before or during the mixing operation. In variant A, the oil becomes uniformly dispersed over the inorganic pigment during the mixing operation. The powder remains flowable in the operation. The mixture is then preferably heated to a temperature in the range from 60 to 150° C. and more preferably to a temperature in the range from 90 to 140° C. before steps b) or b′). This is followed, in variant A, by adding the waxes in the form of powders, flakes, pieces or in the molten state to the oil-treated inorganic pigment or, in variant B, by adding the oil or oils to the inorganic pigment mixed with the waxes. Thereafter, the temperature of the mixture is further increased to a temperature above the congealing points of the Fischer-Tropsch wax and of the second wax. Steps c) or c′) are preferably carried out at 110° C. to 230° C.

The temperature increase is either due to the shearing forces during the mixing operation and/or due to external supply of heat. The wax melts and becomes dispersed over the oil-treated inorganic pigment to form the agent.

Blending the inorganic pigment with the oil(s), the Fischer-Tropsch wax and the second wax in the embodiment of the process according to the present invention where the oil or oils, the Fischer-Tropsch wax and the second wax are added simultaneously to the inorganic pigment (variant C) is carried out at temperatures below or above the congealing points of the waxes. Preferably, mixing the inorganic pigment with the oil(s), the Fischer-Tropsch wax and the second wax is done at temperatures below the congealing points of the waxes. Subsequently, the temperature of the mixture is raised to a temperature above the congealing points of the Fischer-Tropsch wax and of the second wax, preferably to a temperature in the range from 110° C. to 230° C., and the mixing operation is continued. The temperature increase is either due to the shearing forces during the mixing operation and/or due to external supply of heat. The wax melts and becomes dispersed over the inorganic pigment together with the oil to form the agent.

Various heatable mixing assemblies providing a sufficient mixing effect and sufficient shearing forces can be used. Preferably, a heatable Henschel mixer is used.

The particle size of the agents according to the present invention increases monotonously during the mixing operation of the production processes for variants A, B and C. The mixing operation is therefore discontinued at a suitable point in time. When the mixing operation is carried out for too short a time, agents are obtained with too small a particle size. When the mixing time is too long, the agents become too coarse, which may have an adverse effect on dispersibility in asphalt. This leads to nonuniform coloration of the asphalt. The mixing operation is therefore discontinued once the maximum percentage fraction of the agent having a particle size of 1 mm or more, preferably of 1 to 10 mm, more preferably of 1 to 6 mm, based on the total amount of the agent, is reached.

After the mixing operation in variants A, B and C of the production process according to the present invention has been discontinued, the agent of the present invention is cooled down to ambient temperature and subsequently sieved to a particle size range such that at least 50 wt % of the agent has a particle size of 1 mm or more, preferably at least 70 wt % of the agent has a particle size of 1 mm or more and more preferably at least 80 wt % of the agent has a particle size of 1 mm or more,

or
at least 50 wt % of the agent has a particle size in the range from 1 to 10 mm, preferably at least 70 wt % of the agent has a particle size in the range from 1 to 10 mm and more preferably at least 80 wt % of the agent has a particle size in the range from 1 to 10 mm,
or
at least 50 wt % of the agent has a particle size in the range from 1 to 6 mm, more preferably at least 70 wt % of the agent has a particle size in the range from 1 to 6 mm and more preferably at least 80 wt % of the agent has a particle size in the range from 1 to 6 mm.

The agent of the present invention is notable for good flowability, for a low dust content, for good attrition stability and also for high dispersibility in bitumen- or tar-containing building products and also for a similarly intense and comparable hue in the application medium compared with the ungranulated inorganic pigment and also for the fact that asphalt colored with the agent of the present invention retains its mechanical strength.

The invention also provides for the use of the agent according to the present invention for coloration of building products, preferably asphalt, bitumen, bituminous mixtures, tar and tar-containing compositions. In this use, the agent of the present invention is added to the building product by mixing at a temperature below its congealing point. The mixing operation is continued until uniform coloration of the building product is obtained.

The invention also provides a process for coloration of building products, preferably asphalt, bitumen, bituminous mixtures, tar and tar-containing compositions comprising mixing the agent of the present invention with the building product above the softening point thereof. In this process, the building product is mixed with the agent until uniform coloration of the building product is obtained.

The invention likewise provides building products, preferably asphalt, bitumen, bituminous mixtures, tar and tar-containing compositions, colored with the agent of the present invention.

The subject matter of the present invention will be apparent not just from the subject matter of the individual claims, but also from the combination of individual claims with each or one another. The same holds for all parameters disclosed in the description and any combinations thereof.

### EXAMPLES AND METHODS

### I. Description of Measuring and Testing Methods Used

The results of measurements regarding Examples 1 to 5 are summarized in table 1.

### I.1 Dispersibility in Asphalt

Dispersibility in asphalt was determined as follows: The aggregates (mineral fillers for producing the asphalt) were homogenized in a heatable laboratory mixer (from Rego) together with Pigmental® 50/70 roadbuilding bitumen (commercial product from TOTAL Bitumen Deutschland GmbH) at 180° C. for 30 seconds. Thereafter, the pigment sample to be measured, i.e., the agents as per the examples, was added, which was followed by mixing at 180° C. for a further 120 seconds. The amount of pigment sample added was in each case 3 wt %, based on the entire composition. The mixture was used to produce Marshall specimens (“The Shell Bitumen Handbook, Shell Bitumen U.K., 1990, pages 230-232). Hue differences of Marshall specimens were evaluated colorimetrically by comparing the red values a* in the full shade versus a Marshall specimen produced using an identical amount of Bayferrox® 130 powder (iron oxide red pigment from LANXESS Deutschland GmbH, 2001 standard with color measurement absolute values Rx=6.46, Ry=5.12, Rz=3.92) (measured using: Minolta Chromameter II, standard illuminant C, CIELAB system, DIN 5033, DIN 6174). Differences in the a* values (Δa* values) below 1.0 units are visually indistinguishable. When the amount of the a* value of the test specimen colored with the sample to be measured is smaller than that of the test specimen colored with the Bayferrox® 130 powder reference, this points to a lower dispersibility on the part of the in-measurement sample versus the powder reference. The smaller the amount of the Δa* values in this measurement, the more alike the hue is for the different measurements, which points to a low difference in dispersibility of the in-measurement sample compared with the Bayferrox® 130 powder reference.

### I.2 Determining the Particle Size Fraction of Agents

The particle size fraction was determined using a Retsch Vibtronic VE 1 sieve vibrator with sieve sets with 1 and 6 mm (sieve sets to DIN ISO 3310). The agent (50.0 g) in piece form was weighed onto the uppermost, largest sieve. The sieve set tower was vibrated at 1 mm vibration intensity for 2 min. Thereafter, each individual sieve was weighed and the sieve fraction determined.

### I.3 Determining the Attrition Value of Agents

The attrition value was determined using a Rhewum LPS 200 MC air jet siever. The following settings were chosen: nozzle 1 mm, volume flow rate 35 m³/h, 1 mm sieve, rotary speed 18 rpm. The sieve to DIN ISO 3310 was weighed empty and then with 20 g of sample. Thereafter, the siever was switched on and the sample was put under 1, 2, 3, 4 and 5 minutes of stress (by the sieved material being whirled up by the air jet). After every minute, the sieve with the sample was weighed and later placed on the siever and sieved some more.

Calibration:(20 g(original weight)−final weight)/20 g of original weight×100=wt % of subsize(attrition value)

Good attrition stability (=low attrition value) as per this test is defined to be an amount of 10 wt % or less, preferably 5 wt % or less and more preferably of 2 wt % or less of subsize as measured after whirling up the sieved material for a period of 5 minutes (=attrition value after 5 min, see table 1).

### I.4 Determination of Needle Penetration

The test was carried out using defined mixed material (AC 8 DN asphalt concrete cover layer with 50/70 road bitumen from Th-Asphalt, MA Eschenau, Hormersdorf, Zirndorf, in accordance with the Technical Supply Conditions for Asphalt Mix Material for the Construction of Traffic Surfaces, TL Asphalt-SW 07). The concentration of agents as per the examples was 2.73 wt % in the entire, colored asphalt mixture. The agents as per the examples were dispersed in the mixed material at the same temperature and in the course of the same mixing times as described in method I.1. Needle penetration was determined in the recovered binder (as per TP Asphalt-SW) to DIN EN 1426.

### I.5 Determining the Ring and Ball Softening Point

The test was carried out using defined mixed material (AC 8 DN asphalt concrete cover layer with 50/70 road bitumen from Th-Asphalt, MA Eschenau, Hormersdorf, Zirndorf, in accordance with the Technical Supply Conditions for Asphalt Mix Material for the Construction of Traffic Surfaces, TL Asphalt-StB 07). The concentration of agents as per the examples was 2.73 wt % in the entire, colored asphalt mixture. The agents as per the examples were dispersed in the mixed material at the same temperature and in the course of the same mixing times as described in method I.1. The ring and ball softening point was determined in the recovered binder (as per TP Asphalt-StB) to DIN EN 1427.

### I.6 Determination of Void Content

For the test, Marshal specimens to TP Asphalt-StB were carried out using defined mixed material (AC 8 DN asphalt concrete cover layer with 50/70 road bitumen from Th-Asphalt, MA Eschenau, Hormersdorf, Zirndorf, in accordance with the Technical Supply Conditions for Asphalt Mix Material for the Construction of Traffic Surfaces, TL Asphalt-StB 07). The concentration of agents as per the examples was 2.73 wt % in the entire, colored asphalt mixture. The agents as per the examples were dispersed in the mixed material at the same temperature and in the course of the same mixing times as described in method I.1. For the test, the apparent density of pigmented asphalt mix material and the envelope density of pigmented asphalt specimens (both properties to TP Asphalt-StB) were determined. Void content V computes from the apparent density of the asphalt mixed material (pm) and the envelope density (pb) of the test specimen according to the equation:

V=((pm−pb)/pm)*100.

### II: Examples

### Properties of Employed Inorganic Pigments, Oils and Waxes

Bayferrox® 130 pigment powder from Lanxess Deutschland GmbH: hematite (red iron oxide) having a BET surface area (to DIN ISO 9277) of 7-9 m²/g

Energol RC-R 100 from BP: mineral oil having a kinematic viscosity of about 100 cSt at 40° C. (DIN 51562)

Sasobit®: Fischer-Tropsch wax from Sasol; properties: congealing point (ASTM D 938) about 100° C., needle penetration at 25° C. (ASTM D 1321) to 0.1 mm, penetration at 65° C. (ASTM D 1321) to 1.3 mm

Tecero® 30332: microcrystalline wax from Wachs-u. Ceresin-Fabriken Th. C. Tromm

GmbH; properties: congealing point (ISO 2207): 90-95° C., penetration at 25° C. (DIN 51 579) 0.4-0.7 mm, viscosity at 120° C. (DIN 53 019) 7-11 mPas.

### Example 1

To 15.0 kg of Bayferrox® 130 iron oxide red pigment was added 0.150 kg of Energol RC-R 100 compressor oil at room temperature and the mixture was heated to about 100° C., and mixed for about 5 min, in a 75 L FM75 Henschel mixer, which was followed by the addition of 1.32 kg of Tecerowachs® 30332 wax and 1.32 kg of Sasobit® and the entire mixture was further mixed for about 15 min (tool speed about 780 rpm) and heated up to about 200° C. in the process. The temperature was measured in-product.

The agent was then discharged via a valve, cooled down, sieved and weighed. The yield of agent was computed for the entire particle-size range between 1 to 6 mm (table 1).

### Example 2

To 15.0 kg of Bayferrox® 130 iron oxide red pigment was added 0.150 kg of Energol RC-R 100 compressor oil, 1.32 kg of Tecerowachs® 30332 wax and 1.32 kg of Sasobit® at room temperature. The mixture was mixed in a 75 L FM75 Henschel mixer for about 15 min (tool speed about 780 rpm) and heated up to about 200° C. in the process. The temperature was measured in-product.

The agent was then discharged via a valve, cooled down, sieved and weighed. The yield of agent was computed for the entire particle-size range between 1 to 6 mm (table 1).

### Example 3

To 15.0 kg of Bayferrox® 130 iron oxide red pigment was added 0.150 kg of Energol RC-R 100 compressor oil, 1.32 kg of Tecerowachs® 30332 wax and 1.32 kg of Sasobit® at room temperature and the mixture was mixed in a 75 L FM75 Henschel mixer for about 35 min at up to about 130° C. without external heating (tool speed 780 rpm). The temperature was measured in-product.

The agent was then discharged via a valve, cooled down, sieved and weighed. The yield of agent was computed for the entire particle-size range between 1 to 6 mm (table 1).

### Example 4

To 15.0 kg of Bayferrox® 130 iron oxide red pigment was added 0.150 kg of Energol RC-R 100 compressor oil at room temperature and the mixture was heated to about 100° C., and mixed for about 5 min, in a 75 L FM75 Henschel mixer, which was followed by the addition of 1.19 kg of Tecerowachs® 30332 wax and 1.46 kg of Sasobit® and the entire mixture was further mixed for about 15 min (tool speed about 780 rpm) and heated up to about 200° C. in the process. The temperature was measured in-product.

The agent was then discharged via a valve, cooled down, sieved and weighed. The yield of agent was computed for the entire particle-size range between Ito 6 mm (table 1).

### Example 5

To 15.0 kg of Bayferrox® 130 iron oxide red pigment was added 0.150 kg of Energol RC-R 100 compressor oil, 1.19 kg of Tecerowachs® 30332 wax and 1.46 kg of Sasobit® at room temperature. The mixture was mixed in a 75 L FM75 Henschel mixer for 15 min (tool speed about 780 rpm) and heated up to about 200° C. in the process. The temperature was measured in-product.

The agent was then discharged via a valve, cooled down, sieved and weighed. The yield of agent was computed for the entire particle-size range between 1 to 6 mm (table 1).

Examples 1 to 5 provide inventive agents having the yields for the particle size fraction 1-6 mm above 70% with good color properties. Colorimetrically, the samples were comparable to Bayferrox® 130 powder (2001 standard). These agents have a very high attrition stability low attrition value) and advantageous asphalt-technological properties (table 1). The asphalt-technological properties measured are good indicators of adequate strength on the part of asphalt colored with the agents of the present invention.

TABLE 1
Inventive examples

| | Yield of | Attrition | | | | Dispersibility |
|---|---|---|---|---|---|---|
| | sieve | value | | | Ring and ball | measured via |
| | fraction | after | Needle | Void | softening | Δa* |
| Agent as | 1-6 mm | 5 min | penetration | content | point | c) |
| per | wt % | wt % | a) | vol % | b) | CIELAB units |
| Example 1 | >70 | <5 | nd | nd | nd | ±1.0 |
| Example 2 | >70 | <5 | ≦ | <5 | ≧ | ±1.0 |
| Example 3 | >70 | <5 | nd | nd | nd | ±1.0 |
| Example 4 | >70 | <5 | nd | nd | nd | ±1.0 |
| Example 5 | >70 | <5 | ≦ | <5 | ≧ | ±1.0 |

nd => not determined
a) ≦ denotes: a needle penetration not more than that of unpigmented asphalt,
b) ≧ denotes: a ring and ball softening point not less than that of unpigmented asphalt,
c) what was measured was the difference Δa* (= delta a*) = a* value (agent) minus a* value (reference) in the bitumen. Reference: Bayferrox 130 powder 2001 standard

### Example 6

### Comparative Example

Example 1 of patent document EP 0 567 882 B1 (producing an agent via pan granulation) was repeated. A color shift Δa* of −0.6 CIELAB units versus Bayferrox® 130 powder (2001 standard) was found. However, the agents only have very low attrition stability (attrition value after 5 minutes equal to more than 20 wt %).

What is claimed is:

1. An agent where at least 50 wt % of the agent has a particle size of 1 mm or more, containing
at least one inorganic pigment selected from the group of iron oxides, iron oxide hydroxides, chromium oxides, titanium dioxides and/or mixed-phase pigments based on metal oxides,
one or more oils,
at least one Fischer-Tropsch wax having a congealing point between 50 and 140° C. and a needle penetration at 25° C. of up to 1 mm, and at least one second wax having a congealing point between 50 and 140° C., wherein this wax is not a Fischer-Tropsch wax nor a polyolefin wax.

2. The agent as claimed in claim 1, characterized in that, characterized in that the proportion of Fischer-Tropsch wax relative to the total amount of Fischer-Tropsch wax and second wax is from 20 wt % to 80 wt %.

3. The agent as claimed in one or more of claim 1 or 2, characterized in that the total amount of oil or oils is from 0.1 to 5.0 wt % based on the total amount of the agent.

4. The agent as claimed in one or more of claims 1 to 3, characterized in that the second wax is selected from the group of mineral waxes, montan waxes, vegetable waxes and/or animal waxes.

5. The agent as claimed in one or more of claims 1 to 4, characterized in that the total amount of Fischer-Tropsch wax and second wax is from 5 to 25 wt % based on the total amount of the agent.

6. A process for producing agents as claimed in one or more of claims 1 to 5, characterized in that either
a) at least one inorganic pigment is mixed with one or more oils and
b) the mix of step a) is mixed with one or more Fischer-Tropsch waxes and one or more second waxes,
c) the mixture of step b) is further mixed at a temperature above the congealing points of the Fischer-Tropsch waxes and of the second waxes,
or
a′) at least one inorganic pigment is mixed with the Fischer-Tropsch wax and the second wax and
b′) the mix of step a′) is mixed with one or more oils,
c′) the mixture of step b′) is further mixed at a temperature above the congealing points of the Fischer-Tropsch waxes and of the second waxes,
or
at least one inorganic pigment is simultaneously mixed with one or more oils and with one or more Fischer-Tropsch waxes and one or more second waxes, and the mixture is then further mixed at a temperature above the congealing points of the Fischer-Tropsch waxes and of the second waxes.

7. The process for producing agents as claimed in claim 6, characterized in that the agent formed is cooled down to ambient temperature and then sieved to a particle size range such that at least 50 wt % of the agent has a particle size of 1 mm or more.

8. The process for producing agents as claimed in claim 6 or 7, characterized in that steps a) or a′) are carried out below the congealing points of the Fischer-Tropsch wax and of the second wax.

9. The process for producing agents as claimed in one or more of claims 6 to 8, characterized in that the mixture is heated to a temperature in the range from 60° C. to 150° C. before steps b) or b′).

10. The process for producing agents as claimed in one or more of claims 6 to 9, characterized in that steps c) or c′) are carried out at 110° C. to 230° C.

11. The process for producing agents as claimed in one or more of claims 6 to 10, characterized in that the temperature of the mixture is raised to a temperature in the range from 110° C. to 230° C. after simultaneous addition of oil or oils, Fischer-Tropsch wax and second wax to the inorganic pigment.

12. The use of agents as claimed in one or more of claims 1 to 5 for coloration of building products, preferably asphalt, bitumen, bituminous mixtures, tar and tar-containing compositions.

13. A process for coloration of building products, preferably asphalt, bitumen, bituminous mixtures, tar and tar-containing compositions comprising mixing the agent as claimed in one or more of claims 1 to 5 with the building product above the softening point thereof.

14. A building product characterized in that it is colored with an agent as claimed in one or more of claims 1 to 25.
